(19) United States
(12) Patent Application Publication
(10) Pub. No.: US 2025/0091097 A1
(43) Pub. Date: Mar. 20, 2025

(54) CLEANER RECIPROCATING STRUCTURE AND HANDHELD CLEANER

(71) Applicant: ZHEJIANG QIANJI INTELLIGENT TECHNOLOGY CO., LTD., Jinhua, Zhejiang (CN)

(72) Inventors: Keke FU, Jinhua (CN); Jin LI, Jinhua (CN)

(21) Appl. No.: 18/580,379

(22) PCT Filed: Jul. 15, 2022
(86) PCT No.: PCT/CN2022/106035

§ 371 Date: Jan. 18, 2024

(30) Foreign Application Priority Data
Jul. 19, 2021 (CN) 202110813731.8

(51) Int. Cl. B08B 3/02; B05B 3/02; B05B 7/02

(52) U.S. Cl. CPC B08B 3/026; B05B 3/02; B05B 7/02; B08B 2203/027

(57) ABSTRACT

A cleaner reciprocating structure comprises a reciprocating mechanism, a water pump assembly, and a second guide assembly. During use, a reciprocating shaft is connected to a driving assembly, and the driving assembly is operated to drive the reciprocating shaft to rotate. Since a first guiding assembly is in guiding fit with a guiding portion on the reciprocating shaft, and a sleeve is connected to the first guiding assembly, the sleeve performs reciprocating movement in the length direction of the reciprocating shaft under the rotation of the reciprocating shaft. Since a plunger is connected to the sleeve, the plunger performs piston reciprocating movement in a reciprocating cavity to suck water from a first channel and discharge the water from a second channel.

### TECHNICAL FIELD

The present disclosure relates to the technical field of cleaning tools, in particular to a reciprocating structure of a cleaning device and a hand-held cleaning device.

### BACKGROUND

With the development of cleaning tool technology, a hand-held cleaning device technology appears. The hand-held cleaning device is a kind of cleaning equipment that uses water pressure to clean dirt, oil, sediment, etc., on surfaces of objects. Since the hand-held cleaning device is handheld and easy to carry, which can meet the cleaning requirements of outdoor activities, the hand-held cleaning device is widely used.

In the conventional technology, the hand-held cleaning device uses a motor to drive a reduction gearbox to drive an eccentric mechanism to form reciprocating movement, and drives a single plunger to reciprocate in a pump body to perform work on water to form water absorption and water discharge, so as to spray water at high pressure and form a cleaning effect on the dirt.

However, in current hand-held cleaning device, when an eccentric mechanism drives the single plunger to reciprocate in the pump body, there is a large eccentric force, so that a pressing plunger slides and rubs in the pump body, the transmission efficiency is not high, the overall working efficiency is low, and the loss is large.

### SUMMARY

Accordingly, it is necessary to provide a reciprocating structure of a cleaning device and a hand-held cleaning device, which can effectively improve the transmission efficiency, improve the working efficiency of the pump body, thereby optimizing the cleaning effect of the cleaning device.

A reciprocating structure of a cleaning device includes: a reciprocating mechanism including a reciprocating shaft, a sleeve, and a first guiding assembly, wherein the sleeve is sleeved on the reciprocating shaft, the reciprocating shaft is provided with a guiding portion, the sleeve is in guiding engagement with the guiding portion through the first guiding assembly, and the reciprocating shaft is configured to rotate under an action of driving assembly to enable the sleeve to reciprocate; a water pump assembly including a pump body and a plunger, wherein the pump body is provided with a reciprocating cavity, a first channel, and a second channel, both the first channel and the second channel are in communication with the reciprocating cavity, the plunger is slidably fitted with the reciprocating cavity, the sleeve is connected to plunger, and the plunger is configured to suck water from the first channel into the reciprocating cavity and to discharge the water from the second channel; and a second guiding assembly including a guiding rail and a second rolling member, wherein the guiding rail is connected to the pump body and extends along a length direction of the reciprocating shaft, and the sleeve is in guiding engagement with the guiding rail through the second rolling member.

During an assembly process of the reciprocating structure of the cleaning device, firstly, the reciprocating shaft is in guiding engagement with the sleeve through the first guiding assembly, then, the plunger is slidably fitted with the reciprocating cavity, and then, the plunger is connected to the sleeve. Finally, the guiding rail is connected to the pump body, and the sleeve is in guiding engagement with the guiding rail through the second rolling member. During use, the reciprocating shaft is connected to the driving assembly, the driving assembly is operated, and the reciprocating shaft is driven to rotate. Since the first guiding assembly is in guiding engagement with the guiding portion of the reciprocating shaft, and the sleeve is connected to the first guiding assembly, the sleeve reciprocates along the length direction of the reciprocating shaft under the rotation of the reciprocating shaft. Since the plunger is connected to the sleeve, the plunger performs a piston reciprocating movement in the reciprocating cavity to suck water from the first channel and discharges water from the second channel. According to the reciprocating structure of the cleaning device, an axial rotation of the reciprocating shaft is converted into a reciprocating movement of the sleeve, and a sliding friction in the conventional eccentric mechanism is changed into a rolling friction of the first guiding assembly, which is conducive to reducing the deflection force, reducing the power loss, and improving the transmission efficiency. It is conducive to increasing the water pressure and flow rate of the outlet water of the water pump assembly, and improving the use experience of the hand-held cleaning device.

In one of the embodiments, the first guiding assembly includes a first rolling member and a connecting base, the first rolling member is connected to the sleeve through the connecting base, and the first rolling member is rollably fitted with the guiding portion.

In one of the embodiments, the first guiding assembly further includes a fixing member sleeved on the sleeve, and the fixing member is limitedly fitted with the first rolling member.

In one of the embodiments, the guiding portion is a guiding groove extending along a circumferential direction of the reciprocating shaft and extending reciprocally along an axial direction of the reciprocating shaft, and the first rolling member is rollably fitted with the guiding groove.

In one of the embodiments, at least two first guiding assemblies are provided, the at least two first guiding assemblies are spaced apart along the circumferential direction of the reciprocating shaft, and the at least two first guiding assemblies are rollably fitted with the guiding portion.

In one of the embodiments, at least two second guiding assemblies are provided, the at least two second guiding assemblies are spaced apart along a circumferential direction of the sleeve, and the at least two second guiding assemblies are rollably fitted with the sleeve.

In one of the embodiments, the reciprocating structure of the cleaning device further includes a check valve group, the check valve group includes a first check valve and a second check valve, the first check valve is in communication between the first channel and the reciprocating cavity, the second check valve is in communication between the second channel and the reciprocating cavity, and the first check valve is opposite in direction to the second check valve.

In one of the embodiments, the pump body is further provided with a third channel and a fourth channel, the check valve group further includes a third check valve and a fourth check valve, the third check valve is in communication between the third channel and the reciprocating cavity, the third check valve is opposite in direction to the first check valve, the fourth check valve in communication between the fourth channel and the reciprocating cavity, and the fourth check valve is opposite in direction to the second check valve.

A hand-held cleaning device includes a driving assembly and the aforementioned reciprocating structure of the cleaning device, and the driving assembly is in driving connection with the reciprocating shaft.

During an assembly process of the hand-held cleaning device, firstly, the reciprocating shaft is in guiding engagement with the sleeve through the first guiding assembly, then, the plunger is slidably fitted with the reciprocating cavity, and then, the plunger is connected to the sleeve. Finally, the guiding rail is connected to the pump body, and the sleeve is in guiding engagement with the guiding rail through the second rolling member. During use, the reciprocating shaft is connected to the driving assembly, the driving assembly is operated, and the reciprocating shaft is driven to rotate. Since the first guiding assembly is in guiding engagement with the guiding portion of the reciprocating shaft, the sleeve is connected to the first guiding assembly, so that the sleeve reciprocates along the length direction of the reciprocating shaft under the rotation of the reciprocating shaft. Since the plunger is connected to the sleeve, the plunger performs a piston reciprocating movement in the reciprocating cavity to suck water from the first channel and discharges water from the second channel. According to the hand-held cleaning device, an axial rotation of the reciprocating shaft is converted into a reciprocating movement of the sleeve, and a sliding friction in the conventional eccentric mechanism is changed into a rolling friction of the first guiding assembly, which is conducive to reducing the deflection force, reducing the power loss, and improving the transmission efficiency. It is conducive to increasing the water pressure and flow rate of the outlet water of the water pump assembly, and improving the use experience of the hand-held cleaning device.

In one of the embodiments, the driving assembly includes a reduction gearbox and a driving member in driving connection with the reduction gearbox, and the reduction gearbox is in transmission connection with the reciprocating shaft.

In one of the embodiments, the driving assembly further includes a transmission member, and the reduction gearbox is in transmission connection with the driving member through the transmission member.

### BRIEF DESCRIPTION OF THE DRAWINGS

The drawings constitute a part of the present disclosure and are used to provide a further understanding of the present disclosure. The exemplary embodiments of the present disclosure and their descriptions are used to explain the present disclosure and do not constitute an improper limitation of the present disclosure.

In order to illustrate the embodiments of the present disclosure more clearly, the drawings used in the embodiments will be described briefly. Apparently, the following described drawings are merely for the embodiments of the present disclosure, and other drawings can be derived by those of ordinary skill in the art without any creative effort.

FIG. 1 is a first schematic view of a reciprocating structure of a cleaning device according to an embodiment.

FIG. 2 is an exploded view of the reciprocating structure of the cleaning device according to an embodiment.

FIG. 3 is a schematic view of an internal structure of a hand-held cleaning device according to an embodiment.

FIG. 4 is a second schematic view of the reciprocating structure of the cleaning device according to an embodiment.

### DESCRIPTION OF REFERENCE SIGNS

100. Reciprocating structure of cleaning device; 110. Reciprocating mechanism; 111. Reciprocating shaft; 1111. Guiding portion; 112. Sleeve; 113. First guiding assembly; 1131. First rolling member; 1132. Connecting base; 114. Fixing member; 115. Reciprocating housing; 120. Water pump assembly; 121. Pump body; 1211. Reciprocating cavity; 1212. First channel; 1213. Second channel; 1214. Third channel; 1215. Fourth channel; 122. Plunger; 130. Second guiding assembly; 131. Guiding rail; 132. Second rolling member; 140. Check valve group; 141. First check valve; 142. Second check valve; 143. Third check valve; 144. Fourth check valve: 200. Hand-held cleaning device; 210. Driving assembly; 211. Reduction gearbox; 212. Driving member; 213. Transmission member; 220. Water inlet member; 221. Water inlet quick joint; 230. Water outlet member.

### DETAILED DESCRIPTION OF THE EMBODIMENTS

In order to make the above objects, features and advantages of the present disclosure clear and easier to understand, the specific embodiments of the present disclosure are described in detail below in combination with the accompanying drawings. Many specific details are set forth in the following description to facilitate a full understanding of the present disclosure. However, the present disclosure can be implemented in many ways different from those described herein, and those skilled in the art can make similar improvements without departing from the connotation of the present disclosure. Therefore, the present disclosure is not limited by the specific embodiments disclosed below.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential direction” are based on the azimuth or position relationship shown in the attached drawings, which are only for the convenience of describing the present disclosure and simplifying the description, rather than indicating or implying that the device or element must have a specific azimuth, be constructed and operated in a specific azimuth, so such terms cannot be understood as a limitation of the present disclosure.

In addition, the terms “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present disclosure, “a plurality of” means at least two, such as two, three, etc., unless otherwise expressly and specifically defined.

In the present disclosure, unless otherwise expressly specified and limited, the terms “mount”, “connect”, “contact”, “fix” and other terms should be understood in a broad sense, for example, they can be fixed connections, detachable connections, or integrated. They can be mechanical connection or electrical connection. They can be directly connected or indirectly connected through an intermediate medium. They can be the connection within two elements or the interaction relationship between two elements, unless otherwise expressly limited. For those skilled in the art, the specific meaning of the above terms in the present disclosure can be understood according to the specific situation.

In the present disclosure, unless otherwise expressly specified and limited, the first feature “above” or “below” the second feature may be in direct contact with the first and second features, or the first and second features may be in indirect contact through an intermediate medium. Moreover, the first feature is “above” the second feature, but the first feature is directly above or diagonally above the second feature, or it only means that the horizontal height of the first feature is higher than the second feature. The first feature is “below” of the second feature, which can mean that the first feature is directly below or obliquely below the second feature, or simply that the horizontal height of the first feature is less than that of the second feature.

It should be noted that when an element is called “fixed to” or “provided on” another element, it can be directly on another element or there can be a centered element. When an element is considered to be “connected” to another element, it can be directly connected to another element or there may be intermediate elements at the same time. The terms “vertical”, “horizontal”, “up”, “down”, “left”, “right” and similar expressions used herein are for the purpose of illustration only and do not represent the only embodiment.

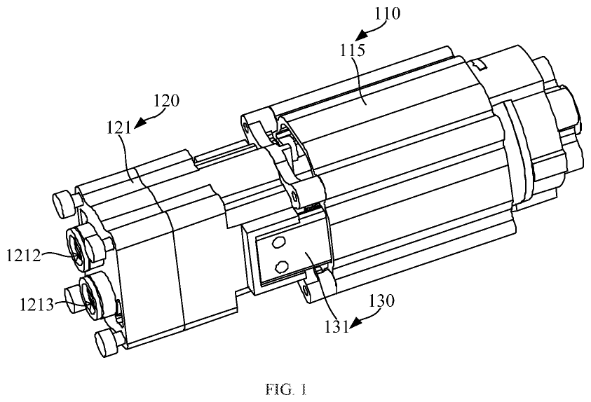

In an embodiment, referring to FIGS. 1 to 3, a reciprocating structure 100 of a cleaning device includes a reciprocating mechanism 110, a water pump assembly 120, and a second guiding assembly 130. The reciprocating mechanism 110 includes a reciprocating shaft 111, a sleeve 112 sleeved on the reciprocating shaft 111, and a first guiding assembly 113. The reciprocating shaft 111 is provided with a guiding portion 1111, and the sleeve 112 is in guiding engagement with the guiding portion 1111 through the first guiding assembly 113. The reciprocating shaft 111 is configured to rotate under an action of driving assembly 210 to enable the sleeve 112 to reciprocate. The water pump assembly 120 includes a pump body 121 and a plunger 122. The pump body 121 is provided with a reciprocating cavity 1211, a first channel 1212, and a second channel 1213, and both the first channel 1212 and the second channel 1213 are in communication with the reciprocating cavity 1211. The plunger 122 is slidably fitted with the reciprocating cavity 1211, and the sleeve 112 is connected to plunger 122. The plunger 122 is configured to suck water from the first channel 1212 into the reciprocating cavity 1211 and to discharge the water from the second channel 1213. The second guiding assembly 130 includes a guiding rail 131 and a second rolling member 132. The guiding rail 131 is connected to the pump body 121 and extends along a length direction of the reciprocating shaft 111. The sleeve 112 is in guiding engagement with the guiding rail 131 through the second rolling member 132.

During an assembly process of the reciprocating structure 100 of the cleaning device, firstly, the reciprocating shaft 111 is in guiding engagement with the sleeve 112 through the first guiding assembly 113, then, the plunger 122 is slidably fitted with the reciprocating cavity 1211, and then, the plunger 122 is connected to the sleeve 112. Finally, the guiding rail 131 is connected to the pump body 121, and the sleeve 112 is in guiding engagement with the guiding rail 131 through the second rolling member 132. During use, the reciprocating shaft 111 is connected to the driving assembly 210, the driving assembly 210 is operated to drive the reciprocating shaft 111 to rotate. Since the first guiding assembly 113 is in guiding engagement with the guiding portion 1111 of the reciprocating shaft 111, and the sleeve 112 is connected to the first guiding assembly 113, the sleeve 112 reciprocates along the length direction of the reciprocating shaft 111 under the rotation of the reciprocating shaft 111. Since the plunger 122 is connected to the sleeve 112, the plunger 122 performs a piston reciprocating movement in the reciprocating cavity 1211 to suck the water from the first channel 1212 and discharge the water from the second channel 1213. According to the reciprocating structure 100 of the cleaning device, an axial rotation of the reciprocating shaft 111 is converted into a reciprocating movement of the sleeve 112, and a sliding friction in the conventional eccentric mechanism is changed into a rolling friction of the first guiding assembly 113, which is conducive to reducing the deflection force, reducing the power loss, and improving the transmission efficiency. It is conducive to increasing the water pressure and flow rate of the outlet water of the water pump assembly, and improving the use experience of the hand-held cleaning device 200.

It should be noted that the guiding engagement between the sleeve 112 and the guiding portion 1111 through the first guiding assembly 113 can be interpreted as that the sleeve 112 abuts against and fits with the guiding portion 1111 through the first guiding assembly 113, such as rolling fit, sliding fit, etc. The guiding portion 1111 guides the first guiding assembly 113, so that the first guiding assembly 113 moves along a contoured trajectory of the guiding portion 1111. The sleeve 112 is relatively stationary with the first guiding assembly 113, thus the sleeve 112 moves relative to the guiding portion 1111. Since the guiding portion 1111 is circumferentially arranged on a guiding shaft, the guiding shaft rotates to enable the sleeve 122 to reciprocate.

It should also be noted that the guiding engagement between the sleeve 112 and the guiding rail 131 through the second rolling member 132 can be interpreted as that the second rolling member 132 and the guiding rail 131 may be in sliding fit, rolling fit or other fit.

In order to further understand and illustrate the length direction of the reciprocating shaft 111, taking FIG. 1 as an example, the length direction of the reciprocating shaft 111 is a direction indicated by any arrow on a straight line Si in FIG. 1.

In an embodiment, referring to FIGS. 1 to 4, the first guiding assembly 113 includes a first rolling member 1131 and a connecting base 1132. The first rolling member 1131 is connected to the sleeve 112 through the connecting base 1132, and the first rolling member 1131 is rollably fitted with the guiding portion 1111. In this way, the rolling fit is conducive to reducing the friction, reducing the power loss, improving the transmission efficiency of the reciprocating mechanism 110, thereby improving the transmission efficiency of the reciprocating structure 100 of the cleaning device.

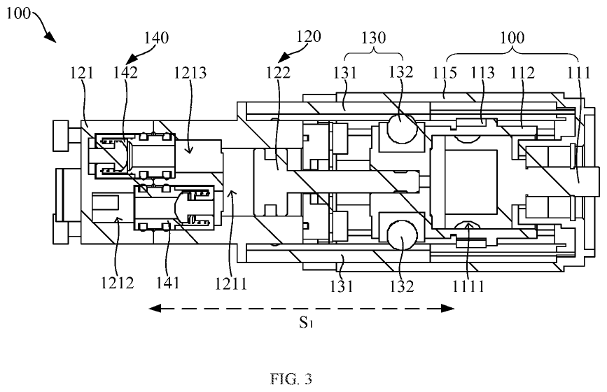

Specifically, referring to FIG. 1 and FIG. 3, the first rolling member 1131 is a ball. The connecting base 1132 is a fixed steel ball holder. The connecting base 1132 is threadedly connected to the sleeve 112. Alternatively, the connecting base 1132 is secured in the sleeve 112 by a circlip. In this way, the rolling smoothness of the first rolling member 1131 is improved, the power loss is further reduced, the transmission efficiency of the transmission mechanism is improved, and the water pressure and the flow rate of the water pump assembly 120 are improved under the same power.

Alternatively, the first rolling member 1131 and the connecting base 1132 are an integrated universal ball bearing. In this way, the structural stability of the first guiding assembly 113 is improved, the rolling friction between the universal ball bearing and the reciprocating shaft 111 is formed under the condition of ensuring the load, the power loss is reduced, the transmission efficiency is improved, and the water pressure and the flow rate of the water pump assembly 120 are improved under the same power.

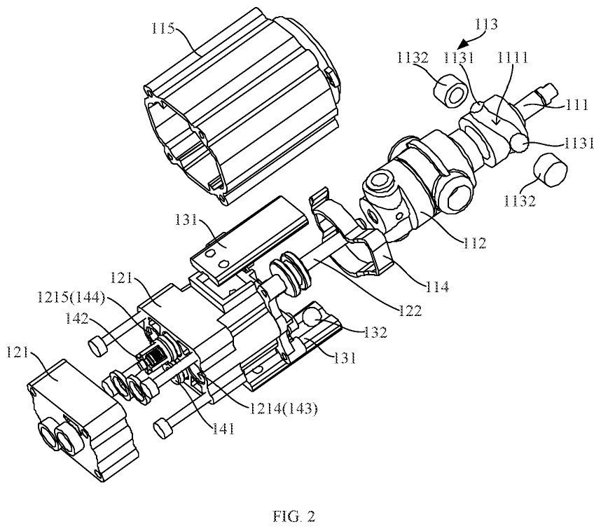

Further, referring to FIG. 1 and FIG. 2, at least two first guiding assemblies 113 are provided, the at least two first guiding assemblies 113 are spaced apart along a circumferential direction of the reciprocating shaft 111, and the at least two first guiding assemblies 113 are rollably fitted with the guiding portion 1111.

Specifically, referring to FIG. 1 and FIG. 3, two first guiding assemblies 113 are provided, and the two first guiding assemblies 113 are symmetrically arranged along the axis of the reciprocating shaft 111. The two first guiding assemblies 113 are rollably fitted with the guiding portion 1111, but are not limited hereto. In this way, on the one hand, it is conducive to improving the guiding function of the first guiding assembly 113 and improving the transmission efficiency of the reciprocating mechanism 110. On the other hand, the two symmetrically arranged first guiding assemblies 113 are conducive to improving the supporting effect of the guiding assemblies on the circumferential direction of the reciprocating shaft 111, which can prevent the reciprocating shaft 111 from swinging to counteract deflection forces with each other, thus further reducing the power loss, enabling the sleeve 112 to move more smoothly to reduce the wear, improving the use quality of the reciprocating structure 100 of the cleaning device.

In an embodiment, referring to FIG. 1 and FIG. 2, the first guiding assembly 113 further includes a fixing member 114 sleeved on the sleeve 112, and the fixing member 114 is limitedly fitted with the first rolling member 1131. In this way, the fixing member 114 can clamp the first rolling member 1131 to prevent the first rolling member 1131 from being detached from the sleeve 112, thereby improving the working reliability of the first guiding assembly 113, and improving the use quality of the reciprocating structure 100 of the cleaning device.

Optionally, the guiding portion 1111 may be a guiding rail 131, a guiding groove, a guiding tube, or other guiding structures.

In an embodiment, referring to FIGS. 1 and 2, the reciprocating mechanism further includes a reciprocating housing. The reciprocating shaft, the sleeve, and the first guiding assembly are provided in the reciprocating housing, and the reciprocating housing is connected to the pump body through the guiding rail. In this way, the reciprocating mechanism and the water pump assembly form an integrated structure, which is conducive to improving the structure compactness and transmission efficiency, and proving greater water pressure and higher flow rate.

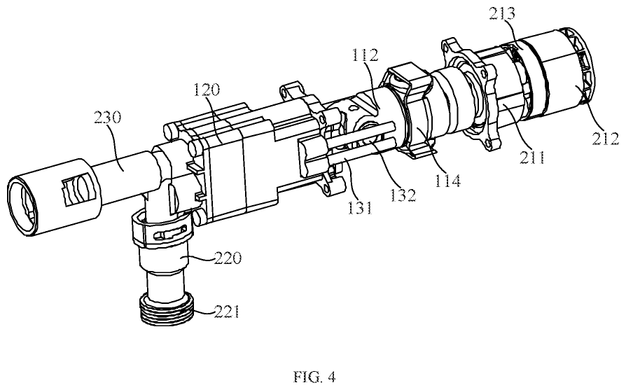

Specifically, referring to FIG. 1 and FIG. 4, the guiding portion 1111 is a guiding groove extending along the circumferential direction of the reciprocating shaft 111 and extending reciprocally along the axial direction of the reciprocating shaft 111. The first rolling member 1131 is rollably fitted with the guiding groove. In this way, the first rolling member 1131 rolls along a contoured trajectory of the guiding groove, so as to drive the sleeve 112 to reciprocate, thereby improving the structural stability of the reciprocating mechanism 110, improving the transmission efficiency of the reciprocating mechanism 110, reducing the loss, and further improving the use reliability of the band-held cleaning device 200. The embodiment provides only one specific embodiment of the guiding portion 1111, but is not limited hereto.

Specifically, referring to FIG. 1 and FIG. 2, the second rolling member 132 is a steel ball. In this way, the rolling manner is conducive to reducing the friction, reducing the power loss, improving the transmission efficiency of the reciprocating mechanism 110 and the driving assembly 210, reducing the power loss, thereby improving the use reliability of the water pump assembly 120.

Further, referring to FIG. 1, the guiding rail 131 is provided with a ball groove, and the second rolling member 132 is rollably fitted with the guiding rail 131 through the ball groove. In this way, it is conducive to improving the smoothness and the guidance of the second rolling member 132 on the guiding rail 131. At the same time, the second rolling member 132 is prevented from falling, the working reliability of the second guiding assembly 130 is improved, so that the working stability and the reliability of the water pump assembly 120 are further improved.

In another embodiment, referring to FIG. 4, the guiding rail 131 includes two guiding posts, and the second rolling member 132 is rollably fitted with the two guiding posts. In this way, the structure of the guiding rail 131 is simplified, the volume of the guiding rail 131 is reduced, the compactness of the cleaning reciprocating structure is improved, and the use quality of the reciprocating structure 100 of the cleaning device is further improved.

In an embodiment, referring to FIGS. 1 to 4, at least two second guiding assemblies 130 are provided, the at least two second guiding assemblies 130 are spaced apart along a circumferential direction of the sleeve 112, and the at least two second guiding assemblies 130 are rollably fitted with the sleeve 112.

Specifically, referring to FIGS. 1 to 4, two second guiding assemblies 130 are provided, the two second guiding assemblies 130 are arranged on opposite sides of the sleeve 112 in the circumferential direction along opposite sides of an axis of the sleeve 112, and the two second guiding assemblies 130 are rollably fitted with the sleeve 112, but are not limited hereto. In this way, it is conducive to further improving the guiding effect and supporting effect of the second guiding assembly 130 on the reciprocating movement of the sleeve 112, preventing the reciprocating movement of the sleeve 112 from being track deviating to a large extent, improving the transmission efficiency of the reciprocating mechanism 110, thereby improving the working stability and reliability of the water pump assembly 120.

In one embodiment, referring to FIG. 1 and FIG. 2, the reciprocating structure 100 of the cleaning device further includes a check valve group 140. The check valve group 140 includes a first check valve 141 and a second check valve 142. The first check valve 141 is in communication between the first channel 1212 and the reciprocating cavity 1211, the second check valve 142 is in communication between the second channel 1213 and the reciprocating cavity 1211, and the first check valve 141 is opposite in direction to the second check valve 142. In this way, due to the one-way conduction effect of the check valve, when the plunger 122 moves, water can only be sucked into the pump housing from the water inlet member 220 through the first check valve 141, and then be discharged from the water outlet member 230 through the second check valve 142, which is conducive to preventing water backflow, and to improving the working reliability of the water pump assembly 120.

In one embodiment, referring to FIG. 1 and FIG. 2, the pump body is further provided with a third channel 1214 and a fourth channel 1215. The check valve group 140 further includes a third check valve 143 and a fourth check valve 144. The third check valve 143 is in communication between the third channel 1214 and the reciprocating cavity 1211, and the third check valve 143 is opposite in direction to the first check valve 141. The fourth check valve 144 in communication between the fourth channel 1215 and the reciprocating cavity 1211, and the fourth check valve 144 is opposite in direction to the second check valve 142. In this way, when the plunger 122 reciprocates in the pump housing, it can perform work both forward and backward. When the plunger 122 moves forward, water is sucked and discharged through the first check valve 141 and the second check valve 142. When the plunger 122 moves backward, water is sucked and discharged through the third check valve 143 and the fourth check valve 144. Since water is continuously discharged when the plunger 122 reciprocates, it is conducive to improving the working efficiency of the water pump assembly 120, thereby improving the water discharging quality and use experience of the hand-held cleaning device 200.

In an embodiment, referring to FIG. 1 and FIG. 2, the plunger 122 is slidably fitted with reciprocating cavity 1211 through a sealing member. In this way, it is conducive to improving the sealing performance of the water pump assembly 120, preventing water leakage, thereby improving the use quality of the reciprocating mechanism 110 of the cleaning device.

In an embodiment, referring to FIGS. 1 to 4, a hand-held cleaning device 200 includes the driving assembly 210 and the aforementioned reciprocating structure 100 of a cleaning device, and the driving assembly 210 is in driving connection with the reciprocating shaft 111.

During an assembly process of the hand-held cleaning device 200, firstly, the reciprocating shaft 111 is in guiding engagement with the sleeve 112 through the first guiding assembly 113, then, the plunger 122 is slidably fitted with the reciprocating cavity 1211, and then, the plunger 122 is connected to the sleeve 112. Finally, the guiding rail 131 is connected to the pump body 121, and the sleeve 112 is in guiding engagement with the guiding rail 131 through the second rolling member 132. During use, the reciprocating shaft 111 is connected to the driving assembly 210, the driving assembly 210 is operated, and the reciprocating shaft 111 is driven to rotate. Since the first guiding assembly 113 is in guiding engagement with the guiding portion 1111 of the reciprocating shaft 111, the sleeve 112 is connected to the first guiding assembly 113, so that the sleeve 112 reciprocates along the length direction of the reciprocating shaft 111 under the rotation of the reciprocating shaft 111. Since the plunger 122 is connected to the sleeve 112, the plunger 122 performs a piston reciprocating movement in the reciprocating cavity 1211 to suck water from the first channel 1212 and discharges water from the second channel 1213. According to the hand-held cleaning device 200, an axial rotation of the reciprocating shaft 111 is converted into a reciprocating movement of the sleeve 112, and a sliding friction in the conventional eccentric mechanism is changed into a rolling friction of the first guiding assembly 113, which is conducive to reducing the deflection force, reducing the power loss, and improving the transmission efficiency. It is conducive to increasing the water pressure and flow rate of the outlet water of the water pump assembly, and improving the use experience of the hand-held cleaning device 200.

In an embodiment, referring to FIGS. 1 to 4, the driving assembly 210 includes a reduction gearbox 211 and a driving member 212 in driving connection with the reduction gearbox 211. The reduction gearbox 211 is in transmission connection with the reciprocating shaft 111. The driving member 212 drives the reduction gearbox 211 to move, thereby driving the reciprocating shaft 111 to rotate, which is conducive to adjusting a rotation speed of the reciprocating shaft 111, and adjusting a movement speed of the plunger 122, adjusting the water pressure and flow rate of the water pump assembly 120, which is conducive to improving the operation stability and use quality of the hand-held cleaning device 200.

Optionally, the driving member 212 may be an electric motor, a hydraulic motor, a pneumatic motor or other driving devices.

Specifically, referring to FIGS. 1 to 4, the driving member 210 is an electric motor. In this way, it is conducive to improving the portability of the driving member 212, and facilitating the charging and carrying of the hand-held cleaning device 200 through the battery driving, thereby improving the use convenience of the hand-held cleaning device 200. The embodiment only provides a specific embodiment of the driving member 212, but is not limited hereto.

In an embodiment, referring to FIGS. 1 to 4, the driving assembly 210 further includes a transmission member 213, and the reduction gearbox 211 is in transmission connection with the driving member 213 through the transmission member 212. In this way, the driving member 212 drives the transmission member 213 to move, so as to drive the reduction gearbox 211 to move, which is conducive to improving the driving effect of the driving member 212 and prolonging the service life of the driving member 212. At the same time, different transmission manners are conducive to improving the compactness of the internal structure of the mounting cavity, reducing the volume and weight, thereby improving the service quality of the hand-held cleaning device 200.

Optionally, the transmission manner of the transmission member 213 may be gear transmission, belt transmission, chain transmission, linkage transmission or other transmission modes.

Specifically, referring to FIG. 1 and FIG. 2, the transmission member 213 is a gear. In this way, it is conducive to ensuring the transmission efficiency of the reciprocating mechanism 110, improving the movement stability of the reciprocating shaft 111, and improving the compactness of the internal structure of the mounting cavity, so as to reduce the volume and weight of the hand-held cleaning device 200, facilitating carrying, and improving the use experience of the hand-held cleaning device 200. The embodiment only provides a specific embodiment of the transmission member 213, but is not limited hereto.

In an embodiment, referring to FIG. 3, the hand-held cleaning device 200 further includes a water inlet member 220 and a water outlet member 230. The water inlet member 220 is in communication with the first channel 1212, and the water outlet member 230 is in communication with the second channel 1213. In this way, the water inlet member 220 is connected to a water storage device or a water supply device, and the water enters the reciprocating cavity 1211 from the water inlet member 220 and is discharged from the water outlet member 230 under the action of the water pump assembly 120, which is conducive to improving the drainage efficiency of the hand-held cleaning device 200.

In an embodiment, the water inlet member 220 is provided with a safety relief valve (not shown) that is in communication between the water inlet member 220 and the plunger 122. In this way, it is conducive to playing a safety protection role in the water pump assembly 120. When a pressure in the pump body 121 exceeds a specified value, the safety relief valve is pushed open, and a part of the water flow out of the pump body 121 is returned to the water inlet member 220, so that the pressure in the pump body 121 is maintained within a safe value range, so as to ensure that the water pump assembly 120 is free from accidents due to excessive pressure, and effectively improve the use safety and reliability of the hand-held cleaning device 200.

In an embodiment, referring to FIG. 1 and FIG. 2, the water inlet member 220 is provided with a water inlet quick joint 221 configured to be detachably connected to the water storage device. In this way, it is conducive to improving the connection stability between the water inlet member 220 and the water storage device, such as a water inlet quick-connection pipe and a water tank, and at the same time it is easy to disassemble, which is conducive to improving the convenience of replacing the water storage device, and improving the convenience of the hand-held cleaning device 200.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

1. A reciprocating structure of a cleaning device, comprising:
a reciprocating mechanism comprising a reciprocating shaft, a sleeve, and a first guiding assembly, wherein the sleeve is sleeved on the reciprocating shaft, the reciprocating shaft is provided with a guiding portion, the sleeve is in guiding engagement with the guiding portion through the first guiding assembly, and the reciprocating shaft is configured to rotate under an action of driving assembly to enable the sleeve to reciprocate;
a water pump assembly comprising a pump body and a plunger, wherein the pump body is provided with a reciprocating cavity, a first channel, and a second channel, both the first channel and the second channel are in communication with the reciprocating cavity, the plunger is slidably fitted with the reciprocating cavity, the sleeve is connected to plunger, and the plunger is configured to suck water from the first channel into the reciprocating cavity and to discharge the water from the second channel; and
a second guiding assembly comprising a guiding rail and a second rolling member, wherein the guiding rail is connected to the pump body and extends along a length direction of the reciprocating shaft, and the sleeve is in guiding engagement with the guiding rail through the second rolling member.

2. The reciprocating structure of the cleaning device according to claim 1, wherein the first guiding assembly comprises a first rolling member and a connecting base, the first rolling member is connected to the sleeve through the connecting base, and the first rolling member is rollably fitted with the guiding portion.

3. The reciprocating structure of the cleaning device according to claim 1, wherein the first guiding assembly further comprises a fixing member sleeved on the sleeve, and the fixing member is limitedly fitted with the first rolling member.

4. The reciprocating structure of the cleaning device according to claim 2, wherein the guiding portion is a guiding groove extending along a circumferential direction of the reciprocating shaft and extending reciprocally along an axial direction of the reciprocating shaft, and the first rolling member is rollably fitted with the guiding groove.

5. The reciprocating structure of the cleaning device according to claim 4, wherein at least two first guiding assemblies are provided, the at least two first guiding assemblies are spaced apart along the circumferential direction of the reciprocating shaft, and the at least two first guiding assemblies are rollably fitted with the guiding portion; and/or
at least two second guiding assemblies are provided, the at least two second guiding assemblies are spaced apart along a circumferential direction of the sleeve, and the at least two second guiding assemblies are rollably fitted with the sleeve.

6. The reciprocating structure of the cleaning device according to claim 1, further comprising a check valve group, wherein the check valve group comprises a first check valve and a second check valve, the first check valve is in communication between the first channel and the reciprocating cavity, the second check valve is in communication between the second channel and the reciprocating cavity, and the first check valve is opposite in direction to the second check valve.

7. The reciprocating structure of the cleaning device according to claim 6, wherein the pump body is further provided with a third channel and a fourth channel, the check valve group further comprises a third check valve and a fourth check valve, the third check valve is in communication between the third channel and the reciprocating cavity, the third check valve is opposite in direction to the first check valve, the fourth check valve in communication between the fourth channel and the reciprocating cavity, and the fourth check valve is opposite in direction to the second check valve.

8. A hand-held cleaning device, comprising a driving assembly and the reciprocating structure of the cleaning device according to claim 1, wherein the driving assembly is in driving connection with the reciprocating shaft.

9. The hand-held cleaning device according to claim 8, wherein the driving assembly comprises a reduction gearbox and a driving member in driving connection with the reduction gearbox, and the reduction gearbox is in transmission connection with the reciprocating shaft.

10. The hand-held cleaning device according to claim 9, wherein the driving assembly further comprises a transmission member, and the reduction gearbox is in transmission connection with the driving member through the transmission member.
